(19) United States
(12) Patent Application Publication
(10) Pub. No.: US 2026/0048860 A1
(43) Pub. Date: Feb. 19, 2026

(54) LUNAR TERRAIN VEHICLE

(71) Applicant: Lunar Outpost Inc., Arvada, CO (US)

(72) Inventors: Andrew Josef Gemer, Lafayette, CO (US); Justin Cyrus, Golden, CO (US); Forrest Meyen, Golden, CO (US); Randy Rodriguez, Escondido, CA (US); Matthew Mitchell, Denver, CO (US)

(21) Appl. No.: 19/301,549

(22) Filed: Aug. 15, 2025

Related U.S. Application Data
(60) Provisional application No. 63/683,644, filed on Aug. 15, 2024.

(51) Int. Cl. B64G 1/16; B60L 8/00; B60N 2/75; B60P 1/00; B60R 7/04; B62D 33/02

(52) U.S. Cl. CPC B64G 1/16; B60L 8/003; B60N 2/75; B60P 1/00; B60R 7/043; B62D 33/02

(57) ABSTRACT

A vehicle is provided, which comprises a plurality of ground-engaging members, an operator area supported by the ground-engaging members and located at least partially above a set of front ground-engaging members, and a step located at a front of the vehicle, wherein the step is rotatably and/or translationally coupled to the vehicle to facilitate entry into the operator area in a first configuration. In an example, the vehicle further comprises a bed located at a rear of the vehicle. In another example, the vehicle further comprises a solar panel rotatably coupled to the vehicle above the bed of the vehicle. In a further example, the solar panel is movable in a vertical direction. In yet another example, the vehicle further comprises a radiator rearward of the operator area. In a further still example, the radiator is switchably coupled to a thermal management system of the vehicle.

### CROSS-REFERENCE TO RELATED APPLICATION

This application claims priority to U.S. Provisional Application No. 63/683,644, titled “LUNAR TERRAIN VEHICLE,” filed on Aug. 15, 2024, the entire disclosure of which is hereby incorporated by reference in its entirety.

### BACKGROUND

A vehicle may facilitate exploration and/or transport of cargo. However, such a vehicle used in the context of lunar exploration, among other environments, may have special associated considerations, including thermal management, solar panel positioning, and ease of access to cargo and/or tools, as well as usability by operators/passengers when wearing space suits (e.g., which may restrict movement of the wearer and/or introduce additional safety considerations and bulk).

It is with respect to these and other general considerations that embodiments have been described. Also, although relatively specific problems have been discussed, it should be understood that the embodiments should not be limited to solving the specific problems identified in the background.

### SUMMARY

A vehicle is provided, which comprises a plurality of ground-engaging members, an operator area supported by the ground-engaging members and located at least partially above a set of front ground-engaging members, and a step located at a front of the vehicle, wherein the step is rotatably and/or translationally coupled to the vehicle to facilitate entry into the operator area in a first configuration. In an example, the vehicle further comprises a bed located at a rear of the vehicle. In another example, the vehicle further comprises one or more solar panels rotatably coupled to the vehicle, for example above the bed of the vehicle, thereby enabling adjustment (e.g., for storage and/or for improved energy generation). Additionally or alternatively, such a solar panel is movable in a vertical direction. In yet another example, the vehicle further comprises a radiator rearward of the operator area. In a further still example, the radiator is switchably coupled to a thermal management system of the vehicle.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1A illustrates a front perspective view of an example vehicle in an example configuration, according to aspects described herein.

FIG. 1B illustrates a rear perspective view of the example vehicle of FIG. 1A, according to aspects described herein.

FIG. 1C illustrates a front perspective view of the example vehicle of FIG. 1A in another example configuration, according to aspects described herein.

FIG. 1D illustrates a side view of the example vehicle of FIG. 1A in another example configuration, according to aspects described herein.

FIG. 1E illustrates a rear view of the example vehicle of FIG. 1A in another example configuration, according to aspects described herein.

FIG. 2A illustrates a front perspective view of a vehicle, in which a set of example sensors are depicted according to aspects described herein.

FIG. 2B illustrates a rear perspective view of the vehicle of FIG. 2A, according to aspects described herein.

FIG. 3A illustrates a front perspective view of a vehicle, in which an example thermal control system is depicted according to aspects described herein.

FIG. 3B illustrates a rear perspective view of the vehicle of FIG. 3A, according to aspects described herein.

FIG. 4A illustrates an overview of an example frame for a vehicle according to aspects of the present disclosure.

FIG. 4B illustrates an overview of an example operator area according to aspects of the present disclosure.

FIG. 4C illustrates an overview of example aspects of a vehicle drivetrain according to aspects of the present disclosure.

FIG. 5 illustrates an example of a suitable computing environment in which one or more aspects of the present application may be implemented.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

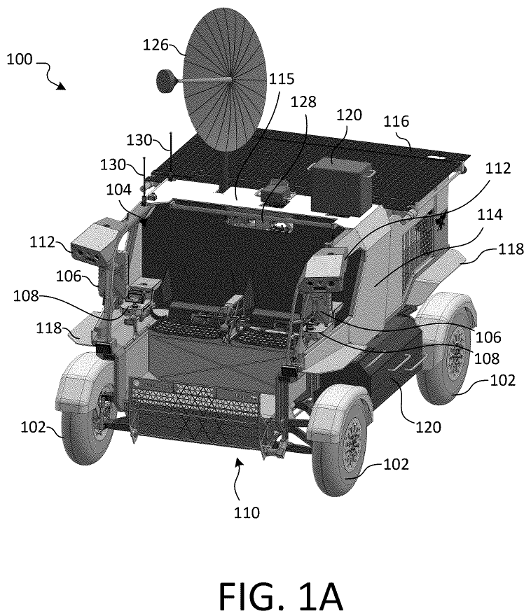

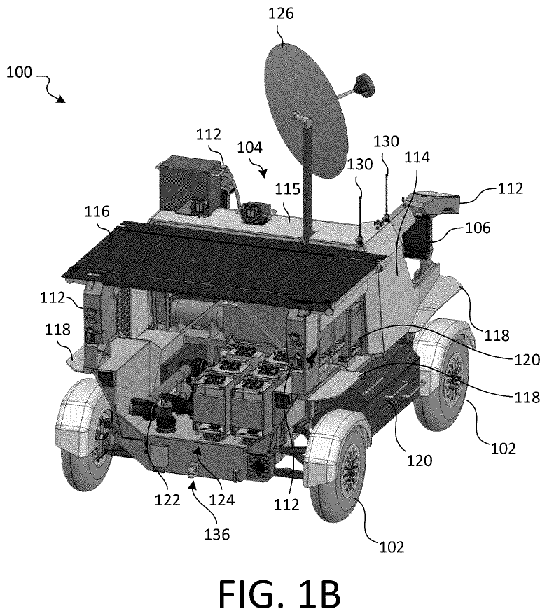

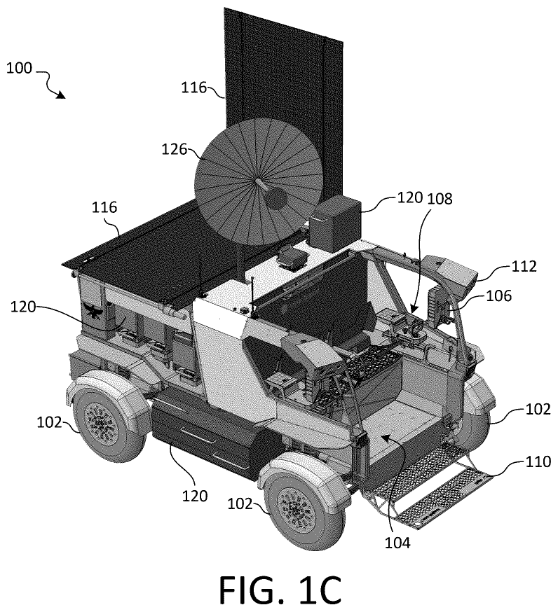

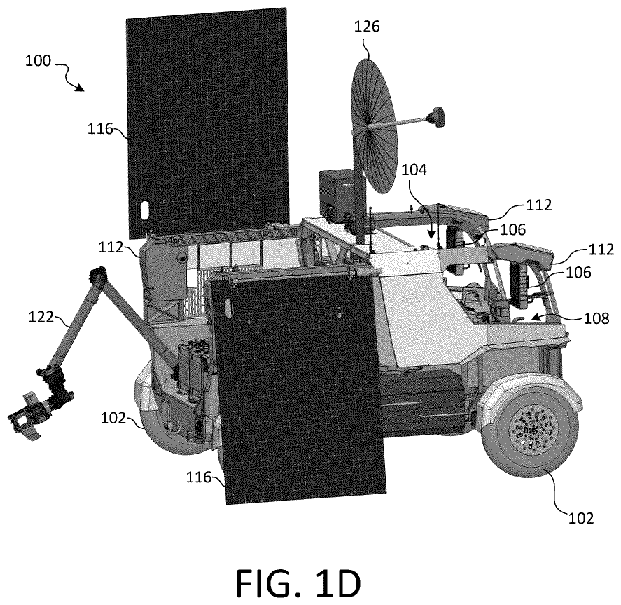

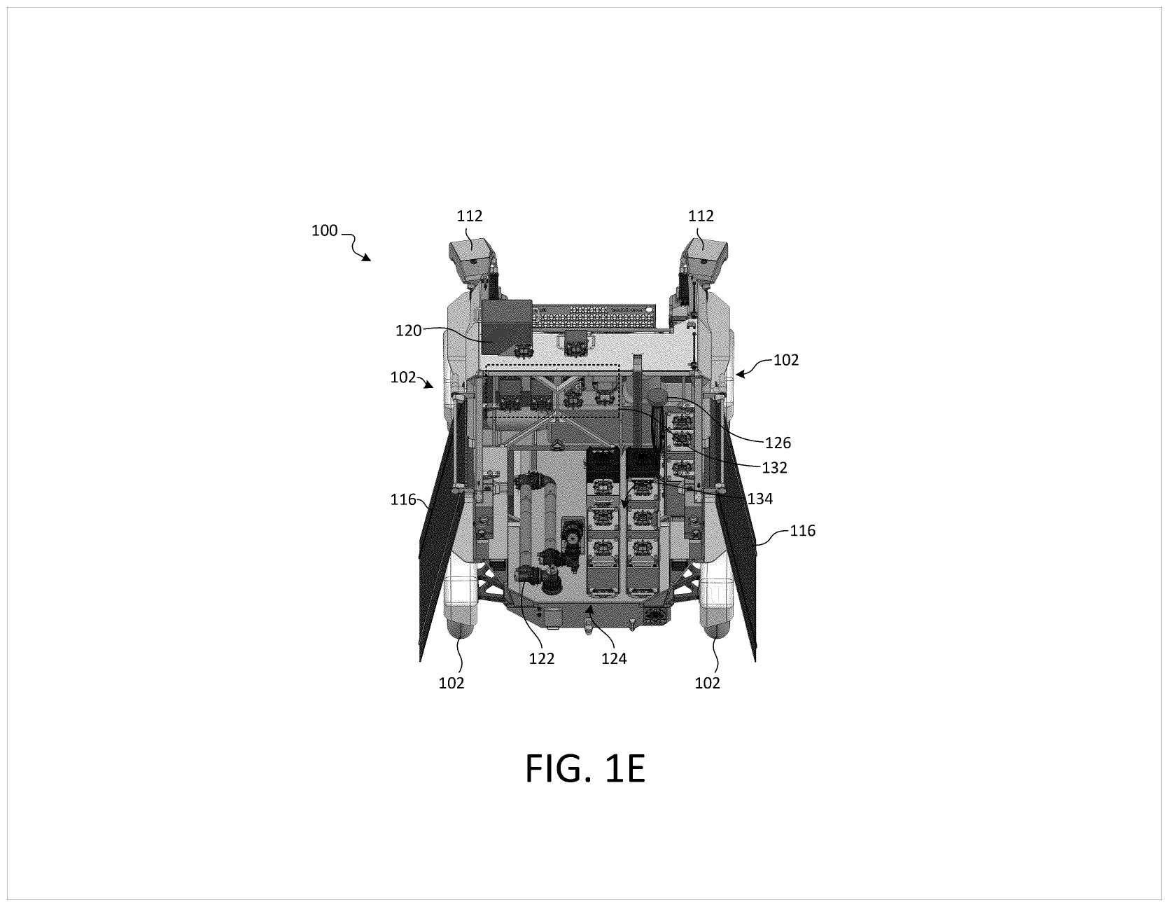

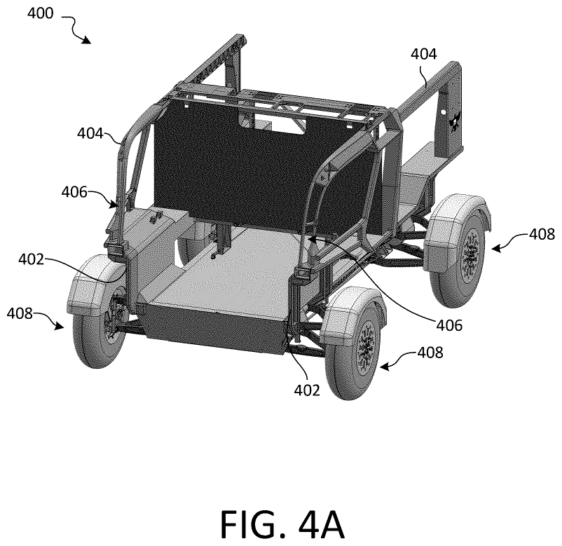

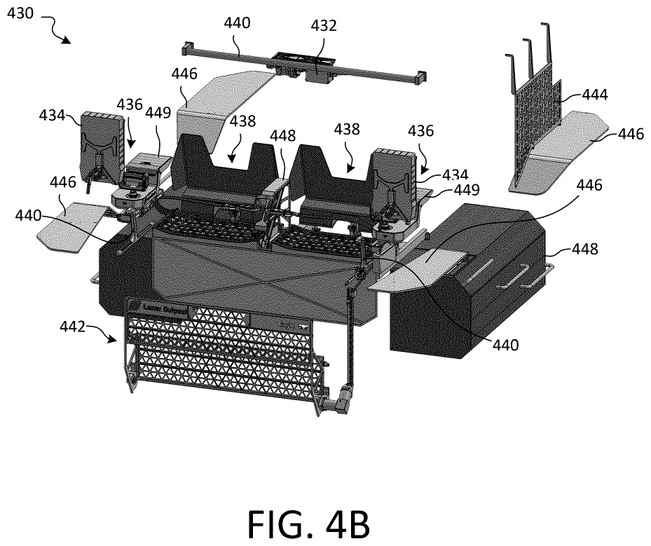

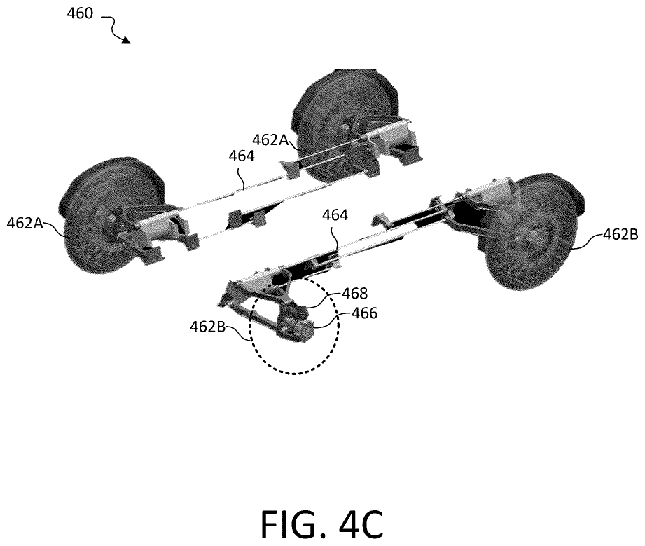

FIGS. 1A-1E depict an example vehicle 100 according to aspects described herein. As illustrated, vehicle 100 includes ground-engaging members 102. In examples, ground-engaging members 102 are driven by a powertrain including one or more electric motors. In such an example, the one or more electric motors are powered by a battery pack (e.g., as may be located beneath operator area 104 and/or bed 124 of vehicle 100). Ground-engaging members 102 support a frame of vehicle 100, examples of which are discussed in more detail below with respect to FIG. 4A. Additionally, vehicle 100 includes solar panels 116, which charge the battery pack and/or provide power to other systems of vehicle 100.

As illustrated, solar panels 116 are rotatably coupled to vehicle 100, such that they articulate about a longitudinal axis of vehicle 100. In examples, solar panels 116 are additionally, or alternatively, capable of vertical movement, such that a first solar panel may be vertically raised/lowered to reduce a degree to which the first solar panel is obstructed by a second solar panel and/or a degree to which the first solar panel obstructs a third solar panel, thereby improving energy generation by the first solar panel and/or third solar panel, respectively. For instance, if vehicle 100 is operating near a pole or at a time when the sun is at a very low angle (e.g., near the horizon), such aspects may enable improved energy generation by vehicle 100. In examples, solar panels 116 are each double-sided. Additionally, or alternatively, solar panels 116 have a storage configuration, as illustrated in FIGS. 1A and 1B. Such a storage configuration may be used for storage, while vehicle 100 is maneuvering, and/or for improved heat retention/shielding of a payload within bed 124, among other examples.

Other example configurations for solar panels 116 are depicted in FIGS. 1C, 1D, and 1E, where one solar panel 116 is deployed, two solar panels 116 are differently deployed (e.g., at substantially 90 degrees and substantially 270 degrees, or vice versa, for energy collection from a side of vehicle 100), and solar panels 116 are each fully deployed (e.g., at substantially 270 degrees for improved access to bed 124), respectively. It will be appreciated that other solar panel configurations in other examples. In examples, solar panels 116 includes passive and/or active dust mitigation (e.g., an electrodynamic dust shield, or “EDS”) to discourage dust deposition on solar panels 116 and/or to remove deposited dust during the service life of vehicle 100.

Vehicle 100 includes operator area 104, which, as illustrated, is configured to accommodate two crewmembers. It will be appreciated that other configurations are contemplated, for example including an additional row of seating and/or with one or more additional seats positioned lateral to the two depicted seats; other crewmember accommodations, such as standing, reclining, or leaning, are also contemplated. Operator area 104 includes displays 106 and controls 108, with which vehicle 100 can be operated. For example, controls 108 are each communicably coupled with a vehicle controller to establish control of the vehicle, and displays 106 each display output from the vehicle controller (e.g., relating to vehicle operation and/or from one or more sensors 112). In the instant example, operator area 104 includes two sets of operator controls (e.g., a display 106 and set of controls 108 for each crewmember), thereby providing redundancy in the event of equipment failure and/or crewmember incapacitation, among other examples. Additional example aspects of operator area 104 are discussed below in more detail with respect to FIG. 4B.

Operator area 104 is at least partially located over front ground-engaging members and is, as depicted, entered from the front of vehicle 100 (e.g., using step 110). As illustrated, step 110 extends laterally across the longitudinal centerline of the vehicle in front of each seat 438 (FIG. 4B), though it will be appreciated that multiple steps (e.g., each corresponding to a respective seat, each of which may be individually actuatable) may be used in other examples. Step 110 is rotatably and/or translationally coupled to the frame of vehicle 100, such that it may be rotated down (e.g., for crewmember entry into operator area 104) or rotated up (e.g., during operation of vehicle 110). FIG. 1C is provided as an example in which step 110 is depicted in a deployed configuration. In examples, step 110 is automatically retracted by a vehicle controller when vehicle 100 is in operation (e.g., traversing terrain) and/or extended when vehicle 100 is stopped/parked, among other examples. While step 110 is depicted as including two steps, it will be appreciated that fewer or additional steps may be included in other examples (e.g., depending on vehicle height and/or a desired step height). Additionally, while step 110 is illustrated as rotating between a stored configuration (e.g., FIG. 1A) and an active configuration (e.g., FIG. 1C), it will be appreciated that any of a variety of other manual and/or assisted actuation mechanisms may be used in other examples.

As a result of positioning operator area 104 toward the front of vehicle 100, improved visibility of the front of vehicle 100 is provided to a crewmember within operator area 104 when maneuvering vehicle 100 (e.g., as compared to seating that is more centrally located or located toward the rear of vehicle 100). Additionally, the stored configuration of step 110 may further facilitate improved visibility according to aspects described herein. Such visibility may reduce the likelihood of encountering obstacles with vehicle 100 and may improve the ability of a crewmember to maneuver across varied terrain, among other examples.

Operator area 104 further comprises winch 128, which is usable to pull a crewmember and/or cargo into operator area 104. As an example, if a crewmember is incapacitated, another crewmember of vehicle 100 may operate winch 128 to pull the incapacitated crewmember into operator area 104 (e.g., by hooking winch 128 to a hard point on the crewmember's spacesuit), thereby facilitating transport of the incapacitated crewmember. It will be appreciated that the depicted location of winch 128 is provided as an example and, in other examples, alternative locations may be used and/or fewer/additional winches and/or boom arm(s) may be included, among other examples. Additional example aspects of winch 128 are detailed below with respect to FIG. 4B.

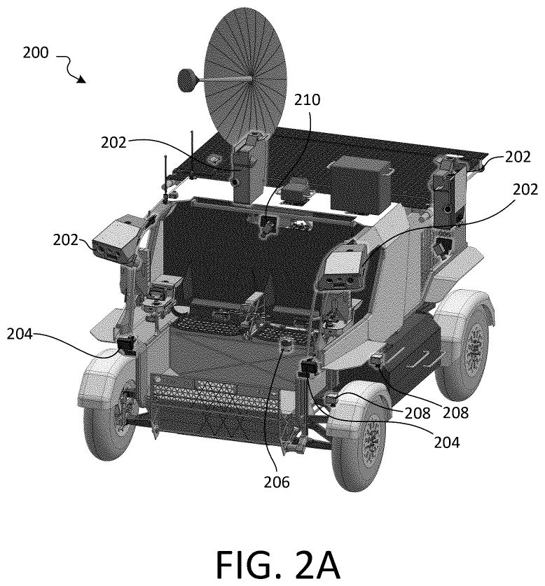

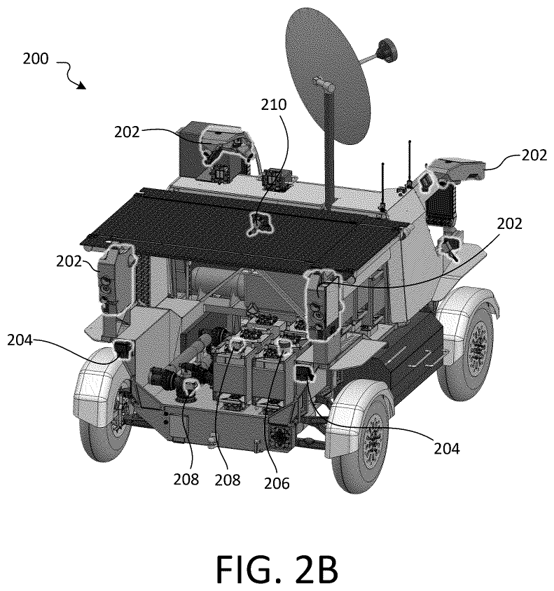

Vehicle 100 includes sensors 112. FIGS. 1A-1E depict example sensor locations, though it will be appreciated that fewer, alternative, or additional sensor locations may be used in other examples. Example sensors include, but are not limited to, visible light cameras (e.g., in a single or stereoscopic configuration), light detection and ranging (LIDAR) sensors, thermal cameras, millimeter wave sensors, X-band radar, and/or star/sun trackers. Sensors 112 may include passive and/or active dust mitigation, similar to solar panels 116. It will be appreciated that each respective location for the depicted sensors 112 may include the same or a different configuration of sensors and that sensors 112 are provided as an example set of sensor locations. Additional examples of such aspects are discussed below with respect to FIGS. 2A and 2B.

One or more visible light cameras and/or LIDAR sensors may be used for vehicle navigation (e.g., to assist a vehicle operator, for teleoperation, and/or for autonomous control). Additionally, or alternatively, one or more thermal cameras may be used for navigation (e.g., to maneuver in a way that decreases or increases heat radiation/absorption), examples of which are described in U.S. Publication No. 2023/0120022, titled “ENVIRONMENT-BASED THERMAL MANAGEMENT,” the entirety of which is hereby incorporated by reference. In examples, one or more millimeter wave sensors and/or X-band radar sensors are used for environmental monitoring, for example to monitor one or more crewmembers, other individuals, and/or objects that are proximate to vehicle 100.

Panels 114 and 115 are located rearward of operator 104. As illustrated, panels 114 are located on either side of vehicle 100, while panel 115 forms part of a roof of vehicle 100. In examples, panels 114 and 115 include or otherwise form one or more radiators, as part of a thermal management system of vehicle 100. In examples, one or more respective radiators of each side of vehicle 100 are switchably coupled to the thermal system of vehicle 100. In examples, the radiators are coated to improve thermal emissivity and/or to reduce absorptivity.

For example, if a left side of vehicle 100 is illuminated by the sun and the thermal system is exhausting heat or otherwise needs to maintain a current temperature, a radiator of the left side is decoupled from the thermal system, thereby reducing heat propagation from the illuminated radiator into the thermal system. In such an example, a right-side radiator may be coupled to the thermal system to further promote heat radiation from an unilluminated side of vehicle 100. Conversely, if the thermal system is configured to heat a component of vehicle 100, the left side radiator of the vehicle is coupled to the thermal system, thereby encouraging heat propagation from the illuminated radiator into the thermal system. In such an example, the right-side radiator may be decoupled to reduce heat loss from the unilluminated radiator.

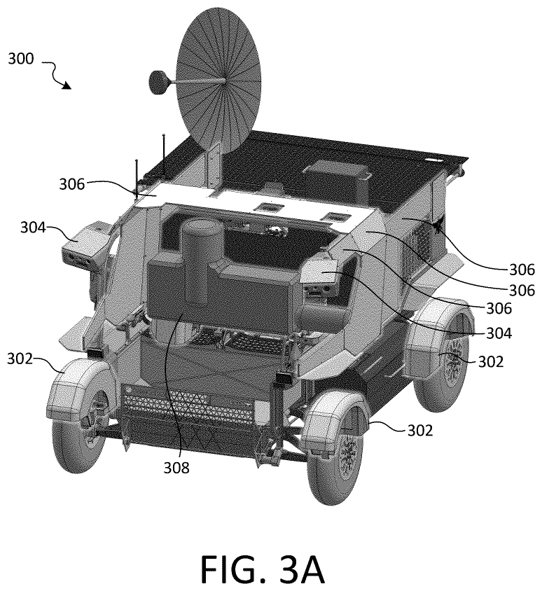

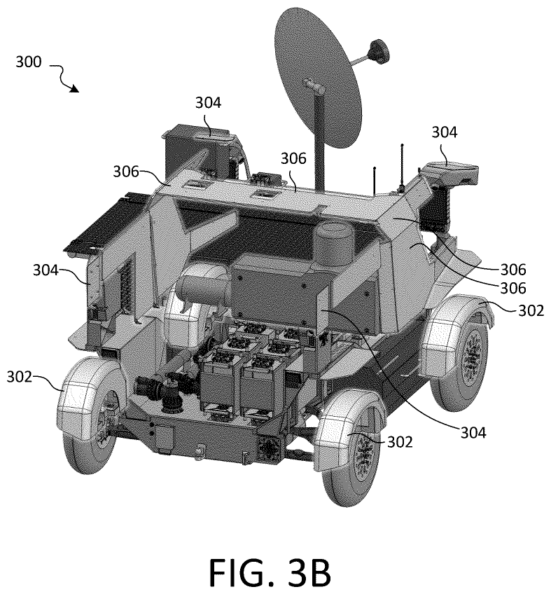

Example aspects of such thermal switching are described by U.S. Provisional Application No. 63/579,794, titled “ACTIVE THERMAL SWITCH,” the entirety of which is hereby incorporated by reference. Similar to solar panels 116, panels 114 and 115 may include passive and/or active dust mitigation to reduce the impact of dust collection on the thermal efficiency thereof. In examples, one or more thermal cameras of sensors 112 are used to determine appropriate actuation of one or more thermal switches of the thermal system of vehicle 100 according to aspects described herein. Additional thermal management aspects are discussed below with respect to FIGS. 3A and 3B.

Moving toward the rear of vehicle 100, work surfaces 118 are depicted. Work surfaces 118 are positioned above ground-engaging members 102, which may reduce dust collection on work surfaces 118 (e.g., as vehicle 100 maneuvers across terrain). As illustrated, vehicle 100 includes a work surface 118 on either side of the vehicle, though it will be appreciated that other configurations are contemplated (e.g., a work surface on only one side of vehicle 100 and/or multiple work surfaces on a side of vehicle 100).

Bed 124 (as is depicted in more detail in FIG. 1E) is located between work surfaces 118, which is usable to store/haul cargo. As illustrated, manipulator 122 is provided (e.g., anchored to bed 124), which is usable to load/unload cargo 134 from bed 124 and/or to interact with the environment surrounding vehicle 100, among other examples. FIG. 1D depicts an example in which manipulator 122 has been deployed from bed 124. In examples, manipulator 122 includes one or more cameras (e.g., for remote operation and/or sample inspection), among any of a variety of additional or alternative sensors. As illustrated, end effector storage 132 is provided, such that an end effector of manipulator 122 may be changed (e.g., by detaching and storing a current end effector and identifying and mechanically coupling with a new end effector from end effector storage 132), among other examples. In examples, manipulator 122 is controllable from vehicle 100 (e.g., via displays 106 and/or controls 108) and/or using a remote device. In examples, aspects of manipulator 122 are similar to those disclosed in U.S. application Ser. No. 19/189,850, titled “ROBOTIC MANIPULATOR,” the entirety of which is hereby incorporated by reference. Returning to FIG. 1E, cargo 134 may be mechanically coupled to bed 124 and/or bed 124 may include one or more retaining features in which cargo 134 may be disposed, among other examples. {may be movable for different configurations/flexibility; could also include vehicle-bed tie down}

Additional example aspects which may be applicable to the vehicle described herein are described in U.S. Publication No. 2023/0129911, titled “SELF-HEATING ELECTRIC MOTOR CONTROL,” U.S. Publication No. 2023/0056248, titled “SAMPLE COLLECTION ASSEMBLY FOR A VEHICLE,” U.S. Publication No. 2024/0270413, titled “VEHICLE LOCKING ASSEMBLY,” and U.S. application Ser. No. 19/189,760, titled “MULTI-ARTICULATED GROUND VEHICLE WITH ACTIVE ATTITUDE AND HEIGHT CONTROL,” the entirety of which are each hereby incorporated by reference.

The ability to pull or tow a trailer is included to increase the cargo-carrying capacity of vehicle 100. The trailer may be unpowered, receive power from the vehicle through trailer coupling 136 (FIG. 1B), or be self-powered (e.g. with onboard batteries, solar panels, and/or drive motors). In examples, tailer coupling 136 supports bi-directional power transfer and/or data communication.

In examples, vehicle 100 includes an active suspension system (e.g., an example of which is depicted in and further discussed with respect to FIG. 4C), which may adjust one or more vehicle characteristics according to a vehicle load and/or environment terrain, among other factors. As an example, vehicle 100 determines a current load weight (e.g., using one or more sensors of the active suspension system and/or as may be indicated by an operator) and adjusts suspension stiffness and/or ground clearance accordingly. Additionally, or alternatively, vehicle 100 increases or decreases a maximum speed and/or steering angle based on the sensed vehicle load.

Vehicle 100 also includes storage 120, which, as illustrated, is located at least partially beneath operator area 104 and bed 124, as well as above work surface 118 on the right side of vehicle 100. It will be appreciated that the depicted locations of storage 120 are provided as examples and, in other examples, fewer, additional, or alternative storage locations may be used. In examples, storage 120 comprises a storage container with a lid that prevents ingress of dust, debris, and/or moisture, and provides the option of thermal control of the storage container (e.g. for samples which are required to remain cold). As another example, storage 120 may include a storage container that does not include a lid (e.g., a bin or cavity), among other examples.

As illustrated, antenna 126 is located at the rear right corner of vehicle 100, and antenna 130 is centrally located, rearward of operator area 104. In examples, antenna 126 comprises a high-gain antenna for Ka-band and/or S-band communication, whereas antenna 130 may each be used for ultra-high frequency (UHF) communication. Antenna 126 may be gimbaled or otherwise adjustable, thereby allowing antenna 126 to be oriented toward a communication target. Additionally, or alternatively, multiple antennae may be used (e.g., at a left and a right side of a vehicle and/or at a front and a rear of a vehicle), such that an antenna may be selectively used depending on which antenna is proximate and/or has the strongest signal, among other examples. Vehicle 100 may thus engage in direct communication (e.g., with Earth, with proximate vehicles and/or devices, etc.) and/or may act as a relay (e.g., between surface communications and Earth-bound communications), among other examples. While example antennas, locations, and corresponding communication technologies are described, it will be appreciated that any of a variety of additional, alternative, or fewer such antennas/locations/technologies may be used.

In examples, vehicle 100 includes one or more lights, for example in operator area 104, to illuminate bed 124, and/or for illuminating its surroundings (e.g., for crewmember activity and/or for illumination while maneuvering). Further, according to aspects described herein, one or more electronic motors of vehicle 100 (e.g., a motor for actuating one or more solar panels 116 and/or step 110, etc.) may include dual windings and/or may be operable via multiple motor controllers, thereby achieving improved fault tolerance. Additionally, or alternatively, aspects that are described as operating under powered control may be manually operable, thereby permitting crewmember operation in the absence of power and/or in the event of equipment failure, among other examples.

As noted above and as depicted by FIGS. 1A-1E, vehicle 100 is configurable according to a number of configurations. In examples, vehicle 100 is configured according to a launch configuration, where solar panels 116 are stored substantially parallel to bed 124, thereby acting as a tonneau cover. In such an example, solar panels 116 may be retained using one or more frangible bolts or other removable fasteners, among other examples, thereby permitting solar panels 116 to be selectively released to progress from the launch configuration to another configuration (e.g., examples of which are described herein). According to such an example launch configuration, one or more of antenna 126 and antennae 130 may each have a corresponding stored configuration. For example, antennae 130 may be retracted within a pillar of vehicle 100, whereas antenna 126 may be stored in bed 124 (as depicted in FIG. 1E).

In a driving configuration, solar panels 116 may each be stored in a configuration that is substantially parallel to bed 124, thereby reducing the likelihood of damage as vehicle 100 traverses terrain and/or providing protection to the contents of bed 124, among other examples. In some instances, at least one panel may be actuated (e.g., at approximately 90 degrees) so as to promote energy collection while driving.

In a payload configuration, solar panels 116 may each be at a substantially 90- or 270-degree configuration, thereby exposing bed 124 (e.g., for payload loading/unloading and/or operation of manipulator 122). In examples, manipulator 122 may perform an inspection of vehicle 100 (e.g., using one or more cameras thereon), manipulate a vehicle payload, and/or engage in sample collection (e.g., which may thus be stored by bed 124 and/or storage 120), among other examples.

While example configurations are described, it will be appreciated that fewer, additional, or alternative configurations may be used in other examples. Additionally, while example solar panel positions are described, it will be appreciated that such aspects may be varied (e.g., depending on a geographic location of vehicle 100 and/or the relationship between vehicle 100 and a light source).

FIGS. 2A and 2B depict a set of example sensors for an example vehicle 200 according to aspects described herein. Aspects of vehicle 200 may be similar to those discussed above with respect to vehicle 100 discussed above with respect to FIGS. 1A-1E and are therefore not necessarily redescribed in detail below.

As illustrated, vehicle 200 comprises upper sensor assemblies 202, lower sensor assemblies 204, inertial measurement unit (IMU) 206, infrared (IR) cameras 208, and cameras 210. Aspects of upper sensor assemblies 202 may be similar to those discussed above with respect to sensors 112 and are therefore not necessarily redescribed in detail. For example, upper sensor assemblies 202 may each comprise LIDAR, a star tracker and/or a Sun tracker, a visible light and/or IR camera, and/or an inertial measurement unit. Such sensors may thus enable a vehicle according to aspects described herein to perform localization without reliance on external systems. Additionally, or alternatively, such aspects may thus provide, for example, 360-degree coverage of an environment surrounding a vehicle, thereby improving situational awareness (e.g., for a crewmember and/or for a remote operator). In examples, an upper sensor assembly 202 further comprises a processor, such that upper sensor assembly 202 processes sensor data (e.g., for sensor control and/or prior to transmission to a vehicle controller). As noted above, while vehicle 200 is illustrated as comprising four upper sensor assemblies 202 (e.g., at each corner of vehicle 200), it will be appreciated that fewer, additional, or alternative assemblies/locations may be used in other examples. Similarly, each such assembly need not comprise the same sensor/processing package according to aspects described herein.

In examples, lower sensor assemblies 204 each comprise radar and a camera (e.g., capturing a field of view that includes a corresponding ground-engaging member), thereby facilitating maneuvering of vehicle 200. In examples, image data from upper sensor assemblies 202 and/or lower sensor assemblies 204 is viewable via one or more displays of the vehicle (e.g., displays 106 of vehicle 100), thereby assisting a crewmember with operation of vehicle 200.

In examples, IR cameras 208 are used to facilitate control of a thermal system of the vehicle (e.g., examples of which are described with respect to FIGS. 3A and 3B) and/or for evaluating the environment in which the vehicle is operating (e.g., for maneuvering according to temperature gradients and/or to track crewmembers), among other examples. Thus, it will be appreciated that, in some examples, IR cameras 208 may be positioned to observe vehicle 200 and/or the environment surrounding vehicle 200. In some examples, one or more cameras of vehicle 200 are used for navigation (e.g., alone or in combination with one or more other sensors), examples of which are described in U.S. Provisional Application No. 63/798,343, titled “STATE MEASUREMENT FOR MOBILE BASES,” the entirety of which is hereby incorporated by reference.

FIGS. 3A and 3B depict an example thermal control system for an example vehicle 300 according to aspects described herein. Aspects of vehicle 300 may be similar to those discussed above with respect to vehicle 100 and/or vehicle 200 discussed above with respect to FIGS. 1A-1E and FIG. 2, respectively, and are therefore not necessarily redescribed in detail below.

As illustrated, vehicle 300 comprises radiators 302, 304, and 306, as well as active thermal control system 308. In examples, radiators 302, 304, and/or 306 are sized and/or shaped to facilitate heat dissipation (e.g., via increased surface area, surface coatings, and/or material density).

As illustrated, radiators 302 are each associated with a corresponding ground-engaging member (e.g., ground-engaging members 102 in FIGS. 1A-1E). In examples, radiators 302 each handle a local heat load (e.g., for one or more electric motors and/or motor controllers associated with a respective ground-engaging member). Additional example aspects of such associated components are discussed below with respect to FIG. 4C.

Similarly, radiators 304 are each associated with a sensor assembly (e.g., sensors 112 and/or upper sensor assemblies 202 discussed above with respect to FIGS. 1A-1E and FIGS. 2A-2B, respectively). Thus, each radiator 304 helps dissipate heat from a corresponding sensor assembly according to aspects described herein.

Aspects of radiators 306 may be similar to those discussed above with respect to panels 114 and/or 115 of vehicle 100 in FIGS. 1A-1E, where the panels form a part of an active thermal control system (e.g., active thermal control system 308). As discussed above, radiators 306 may each be switchably coupled to active thermal control system 308, such that heat transfer (e.g., dissipation of excess heat and/or collection to warm one or more components of vehicle 300) via each respective radiator may be controlled accordingly (e.g., either as a binary switch or according to a degree of heat transfer).

In examples, active thermal control system 308 comprises a fluid tank, a pressurant tank, one or more pumps, and/or one or more valves to achieve the switchable control according to aspects described herein. For example, a pump of active thermal control 308 may be used to circulate fluid from the fluid tank to one or more radiators 306 (e.g., as may be controlled by the one or more valves associated therewith). As another example, pressurant tank may facilitate fluid flow (e.g., instead of or in combination with one or more pumps) within active thermal control system 308, for example as may be the case when working fluid is moved from one zone of active thermal control system 308 to another zone.

FIG. 4A illustrates an overview of an example frame for a vehicle 400 according to aspects of the present disclosure. Aspects of vehicle 400 may be similar to those discussed above with respect to vehicle 100, 200, and/or 300 discussed above with respect to FIGS. 1A-1E, FIG. 2, and FIG. 3, respectively, and are therefore not necessarily redescribed in detail below.

As illustrated, vehicle 400 includes frame 402, which is supported by ground-engaging members (e.g., ground-engaging members 102 in FIGS. 1A-1E), each of which is depicted as forming a part of a respective drive assembly 408 located at each corner of vehicle 400. Frame 402 supports superstructure 404, which forms multiple pillars of vehicle 400 and may support vehicle panels and sensors as discussed above with respect to FIGS. 1A-2B.

As illustrated, superstructure 404 further comprises mobility aids 406, which are usable by a crewmember of vehicle 400 for improved mobility (e.g., to raise/lower oneself into a seat of the operator area, such as seat 438 discussed below with respect to FIG. 4A). As illustrated, mobility aids 406 each form a part of a front pillar of vehicle 404.

As noted above, vehicle 400 further comprises drive assemblies 408, which each comprise a suspension (e.g., a torsion bar suspension), a drive motor, a steer motor, a ground-engaging member, and a fender (e.g., at least a part of which may function as a radiator, as discussed above with respect to reference numeral 302 in FIGS. 3A and 3B). Additional examples of such aspects are discussed below with respect to FIG. 4C. While examples aspects are discussed with respect to each drive assembly 408, it will be appreciated that, in some examples, certain aspects may be shared among multiple drive assemblies (e.g., a shared drive motor, steer motor, and/or suspension).

FIG. 4B illustrates an overview of an example operator area 430, as well as other crewmember features, according to aspects of the present disclosure. As illustrated, operator area 430 comprises seats 438 which are each separated by armrest 448. In examples, each seat 438 comprises a restraint system and a support configured to receive a primary life support system (PLSS) for a crewmember seated thereon.

Operator area 430 further comprises displays 434 and controls 436, aspects of which may be similar to those discussed above with respect to displays 106 and controls 108 of FIGS. 1A-1E. For example, controls 436 each comprise vehicle drive controls, emergency stop functionality, and one or more switches (e.g., as a switchboard). In examples, each display 434 is adjustable, thereby facilitating use by a crewmember while sitting (e.g., in seat 438) or standing (e.g., either within operator area 430 or outside of vehicle 400). Controls 436 are each also located forward of a respective armrest 449, on which a crewmember may rest their arm for improved accuracy while operating controls 436. Vehicle 400 therefore provides resiliency/redundancy by providing a mirrored operator area 430, in which vehicle 400 is operable from each seat 438 (e.g., by either crewmember). Additionally, displays 434 and controls 436 may be usable simultaneously, thereby providing improved crewmember efficiency.

As illustrated, operator area 430 further comprises mobility aid 440 (e.g., which may be similar to mobility aids 406 discussed above with respect to FIG. 4A) and winch 432 (e.g., which may be similar to winch 128 discussed above with respect to FIGS. 1A-1E). In examples, mobility aids of vehicle 400 are marked for improved visibility and are provided for improved accessibility in seated and/or standing positions.

FIG. 4C further comprises step 442, work surfaces 446, tool storage 444, and sample storage 448, aspects of which may be similar to those discussed above with respect to step 110, work surfaces 118, and storage 120 in FIGS. 1A-1E. As noted above, it will be appreciated that the disclosed aspects depict an example configuration and, in other examples, a different configuration of the disclosed elements may be used. For example, operator area 430 may comprise fewer or additional seats and/or associated armrests. Similarly, fewer, additional, or alternative work surfaces 446 may be used, among other examples.

FIG. 4C illustrates an overview of example aspects of a vehicle drivetrain 460 according to aspects of the present disclosure. As illustrated, drivetrain 460 comprises ground-engaging members 462 (e.g., similar to ground-engaging members 102 discussed above with respect to FIGS. 1A-1E), suspension members 464, drive motors 466, and steer motors 468. In the depicted example, suspension members 464 extend longitudinally, such that two right ground-engaging members 462A and two left ground-engaging members 462B are each coupled thereto. The present example comprises a torsion bar suspension, though it will be appreciated that additional or alternative suspension mechanisms may be used in other examples.

As illustrated, front left ground-engaging member 462B is depicted using a dashed circle to provide improved visibility of drive motor 466 and steer motor 468. Since each ground-engaging member 462 has an associated drive motor 466 and steer motor 468, each ground-engaging member 462 may be independently controllable, thereby providing improved maneuverability.

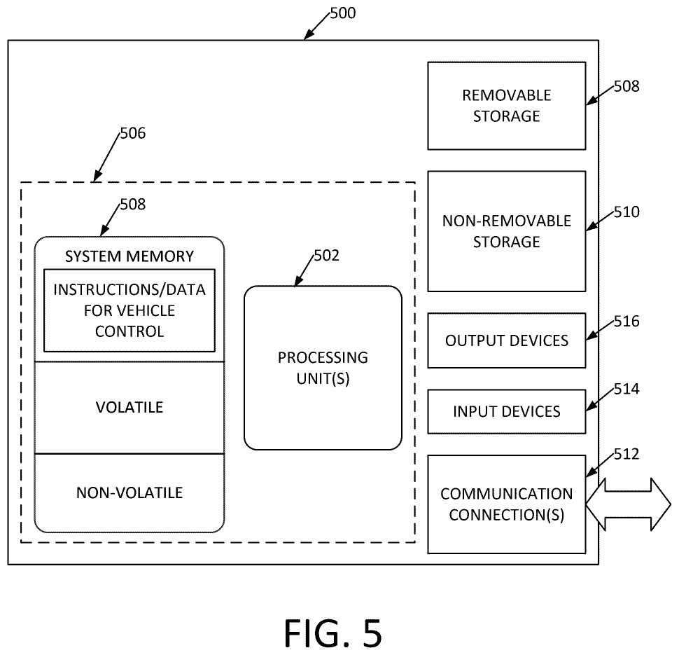

FIG. 5 illustrates an example of a suitable computing environment 500 in which one or more of the present embodiments may be implemented. For example, aspects of computing environment 500 may be used by a controller, such as a vehicle controller of a vehicle (e.g., vehicle 100, 200, 300, or 400 of FIGS. 1A-4C) according to aspects described herein. This is only one example of a suitable computing environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smart phones, network PCs, minicomputers, mainframe computers, distributed computing environments that include any of the above systems or devices, and the like.

In its most basic configuration, computing environment 500 typically may include at least one processing unit 502 and memory 504. Depending on the exact configuration and type of computing device, memory 504 (storing, among other things, APIs, programs, etc. and/or other components or instructions to implement or perform the system and methods disclosed herein, etc.) may be volatile (such as RAM), non-volatile (such as ROM, flash memory, etc.), or some combination of the two. This most basic configuration is illustrated in FIG. 5 by dashed line 506. Further, environment 500 may also include storage devices (removable, 508, and/or non-removable, 510) including, but not limited to, magnetic or optical disks or tape. Similarly, environment 500 may also have input device(s) 514 such as a keyboard, mouse, pen, voice input, etc. and/or output device(s) 516 such as a display, speakers, printer, etc. Also included in the environment may be one or more communication connections, 512, such as LAN, WAN, point to point, etc.

Computing environment 500 may include at least some form of computer readable media. The computer readable media may be any available media that can be accessed by processing unit 502 or other devices comprising the computing environment. For example, the computer readable media may include computer storage media and communication media. The computer storage media may include volatile and nonvolatile, removable and non-removable media implemented in any method or technology for storage of information such as computer readable instructions, data structures, program modules or other data. The computer storage media may include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium, which can be used to store the desired information. The computer storage media may not include communication media.

The communication media may embody computer readable instructions, data structures, program modules, or other data in a modulated data signal such as a carrier wave or other transport mechanism and includes any information delivery media. The term “modulated data signal” may mean a signal that has one or more of its characteristics set or changed in such a manner as to encode information in the signal. For example, the communication media may include a wired media such as a wired network or direct-wired connection, and wireless media such as acoustic, RF, infrared and other wireless media. Combinations of the any of the above should also be included within the scope of computer readable media.

The computing environment 500 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets, and the Internet.

The different aspects described herein may be employed using software, hardware, or a combination of software and hardware to implement and perform the systems and methods disclosed herein. Although specific devices have been recited throughout the disclosure as performing specific functions, one skilled in the art will appreciate that these devices are provided for illustrative purposes, and other devices may be employed to perform the functionality disclosed herein without departing from the scope of the disclosure.

As stated above, a number of program modules and data files may be stored in the system memory 504. While executing on the processing unit 502, program modules (e.g., applications, Input/Output (I/O) management, and other utilities) may perform processes including, but not limited to, one or more of the stages of the operational methods described herein. For example, local vehicle control, manipulator control, and/or teleoperation functionality may be provided according to aspects described herein.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the computing environment 500 on the single integrated circuit (chip). Examples of the present disclosure may also be practiced using other technologies capable of performing logical operations such as, for example, AND, OR, and NOT, including but not limited to mechanical, optical, fluidic, and quantum technologies. In addition, examples of the invention may be practiced within a general purpose computer or in any other circuits or systems.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A vehicle, comprising:
a plurality of ground-engaging members comprising a set of front ground-engaging members and a set of rear ground-engaging members;
an operator area supported by the ground-engaging members and located at least partially above the set of front ground-engaging members; and
a step located at a front of the vehicle, wherein the step is at least one of rotatably or translationally coupled to the vehicle to facilitate entry into the operator area in a first configuration.

2. The vehicle of claim 1, wherein the vehicle further comprises a bed located at least partially above the set of rear ground-engaging members of the vehicle.

3. The vehicle of claim 2, wherein the vehicle further comprises a trailer coupling to pull or tow a trailer.

4. The vehicle of claim 3, wherein the trailer coupling is further configured to provide at least one of a power connection or a data connection to the trailer.

5. The vehicle of claim 2, wherein:
the vehicle further comprises a first work surface located at a first side of the vehicle and a second work surface located at a second side of the vehicle; and
the bed is located at least partially between the first work surface and the second work surface.

6. The vehicle of claim 5, wherein the first work surface and the second work surface are each located at least partially above a respective ground-engaging member of the set of rear ground-engaging members.

7. The vehicle of claim 1, wherein the operator area further comprises a winch disposed therein.

8. The vehicle of claim 1, wherein the vehicle further comprises a vehicle controller configured to rotatably and/or translationally actuate the step between the first configuration and a second configuration depending on whether the vehicle is in operation.

9. The vehicle of claim 8, wherein the vehicle controller is further configured to receive input via a control of the operator area and display information via a display of the operator area.

10. The vehicle of claim 2, further comprising a solar panel rotatably coupled, about a longitudinal axis of the vehicle, above the bed of the vehicle.

11. The vehicle of claim 10, wherein the solar panel is movable in a vertical direction.

12. The vehicle of claim 1, further comprising one or more storage compartments beneath the operator area.

13. The vehicle of claim 2, further comprising one or more storage compartments above the bed.

14. The vehicle of claim 1, further comprising a radiator rearward of the operator area.

15. The vehicle of claim 14, wherein the radiator is switchably coupled to a thermal management system of the vehicle.

16. A vehicle, comprising:
a plurality of ground-engaging members comprising a set of front ground-engaging members and a set of rear ground-engaging members;
an operator area supported by the ground-engaging members and located at least partially above the set of front ground-engaging members;
a bed located at least partially above the set of rear ground-engaging members of the vehicle; and
a plurality of solar panels each configured to rotate about a longitudinal axis of the vehicle, comprising:
a first solar panel rotatably coupled above the bed of the vehicle at a right side of the vehicle; and
a second solar panel rotatably coupled above the bed of the vehicle at a left side of the vehicle.

17. The vehicle of claim 16, wherein the operator area further comprises a plurality of seats that are each separated by an armrest.

18. The vehicle of claim 16, wherein the operator area comprises at least one mobility aid.

19. The vehicle of claim 16, wherein each ground-engaging member of the plurality of ground-engaging members is part of a respective drive assembly that comprises an associated drive motor and an associated steer motor.

20. The vehicle of claim 19, wherein each drive assembly further comprises a radiator thermally coupled to at least one of the drive motor or the steer motor.
